(19) United States
(12) Patent Application Publication
(10) Pub. No.: US 2015/0105991 A1
(43) Pub. Date: Apr. 16, 2015

(54) METHOD AND APPARATUS FOR CONTROLLING AN INTERNAL COMBUSTION ENGINE OF A MOTOR VEHICLE

(71) Applicant: Dr. Ing.h.c. F. Porsche Aktiengesellschaft, Stuttgart (DE)

(72) Inventors: Ulrich Franz Uhlirsch, Blaustein (DE); Sven Norberg, Muehlacker (DE); Volker Schmalzriedt, Korntal-Muenchingen (DE)

(21) Appl. No.: 14/511,233

(22) Filed: Oct. 10, 2014

(30) Foreign Application Priority Data
Oct. 15, 2013 (DE) 10 2013 111358.3

(51) Int. Cl. F02D 41/22; F02P 5/04; F02P 5/155; F02D 41/00

(52) U.S. Cl. CPC F02D 41/22; F02D 41/0002; F02D 41/0087; F02P 5/045; F02P 5/1553
USPC 701/84; 701/102

(57) ABSTRACT

A method for controlling an internal combustion engine of a motor vehicle includes detecting a driving situation of the motor vehicle and determining a setpoint torque (M2) based on the detected driving situation. An expected driving situation of the motor vehicle is ascertained and a torque reserve is determined based on the ascertained expected driving situation of the motor vehicle. The setpoint torque (M2) is set by setting an ignition angle of the internal combustion engine, and the torque reserve (MR) is set by setting a pressure of a gas mixture that flows into the internal combustion engine.

### CROSS REFERENCE TO RELATED APPLICATIONS

Priority is claimed to German Patent Application No. DE 10 2013 111 358.3, filed on Oct. 15, 2013, the entire disclosure of which is hereby incorporated by reference herein.

### FIELD

The present invention relates to a method for controlling an internal combustion engine of a motor vehicle, wherein a setpoint torque is determined on the basis of a detected driving situation of the motor vehicle, and the setpoint torque is set by setting an ignition angle of a throttle valve angle and firing a defined number of cylinders of the internal combustion engine.

The present invention further relates to an apparatus for controlling an internal combustion engine of a motor vehicle, comprising a driving dynamics control unit which is designed to detect a driving situation of the motor vehicle and to determine a setpoint torque for the internal combustion engine on the basis of the detected driving situation, and comprising a control unit which is connected to the driving dynamics control unit and is designed to set an ignition angle of the internal combustion engine on the basis of the determined setpoint torque.

The invention finally relates to a motor vehicle drive train comprising an internal combustion engine for providing drive power.

### BACKGROUND

In the field of motor vehicle drive technology and driving dynamics control, it is generally known to reduce the torque of the internal combustion engine of a motor vehicle by intervening in the engine control system if the driven wheels slip or a yaw rate of the motor vehicle exceeds a predefined value, that is to say the motor vehicle swings out when traveling around a bend.

Furthermore, it is generally known to set or to reduce a torque of an internal combustion engine by means of the ignition angle, and furthermore to set a possible torque by means of an air pressure in the intake manifold of the internal combustion engine. In this case, the set air pressure in the intake manifold, which is set by the throttle valve, determines a maximum possible torque at an optimally set ignition angle, wherein the emitted torque is reduced by an ignition angle retardation operation. The difference between the torque which is set by the ignition angle and also of the number of fired cylinders and the maximum possible torque due to the intake manifold internal pressure, the so-called base torque, forms a so-called torque reserve which can be called up quickly by electronically setting the ignition angle. Setting the torque reserve in this way is known, for example, from DE 10 2009 051 874 A1.

One disadvantage with the known driving dynamics control systems is that the reduction in the emitted torque of the internal combustion engine is performed by setting the intake manifold internal pressure and by means of setting the ignition angle but, after intervention in the engine control system, a maximum possible torque is available only after a certain dead time and, as a result, the driving dynamics is generally restricted.

### SUMMARY

In an embodiment, the present invention provides a method for controlling an internal combustion engine of a motor vehicle including detecting a driving situation of the motor vehicle and determining a setpoint torque (M2) based on the detected driving situation. An expected driving situation of the motor vehicle is ascertained and a torque reserve is determined based on the ascertained expected driving situation of the motor vehicle. The setpoint torque (M2) is set by setting an ignition angle of the internal combustion engine, and the torque reserve (MR) is set by setting a pressure of a gas mixture that flows into the internal combustion engine.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 shows a schematic illustration of a motor vehicle comprising a control unit for controlling the internal combustion engine; and

FIG. 2 shows a schematic block diagram of a method for ascertaining a torque reserve.

### DETAILED DESCRIPTION

An aspect of the present invention provides a method and an apparatus for controlling an internal combustion engine of a motor vehicle, wherein the driving dynamics of the motor vehicle are improved.

In an embodiment, the present invention provides a method in which an expected driving situation of the motor vehicle is ascertained, a torque reserve is determined on the basis of the ascertained expected driving situation of the motor vehicle, and the torque reserve is set by setting a pressure of a gas mixture which flows into the internal combustion engine.

In another embodiment, the present invention provides an apparatus in which a driving dynamics control unit is designed to ascertain an expected driving situation, and to determine a torque reserve for the internal combustion engine on the basis of the expected driving situation, and in that the control unit is designed to set a pressure of a gas mixture, which flows into the internal combustion engine, on the basis of the determined torque reserve.

In yet another embodiment, the present invention provides a drive train with an apparatus for controlling the internal combustion engine according to the present invention.

As a result of a torque reserve being set by means of the pressure of the gas mixture which flows into the internal combustion engine on the basis of an expected driving situation of the motor vehicle, a possible torque, which can be called up, of the internal combustion engine is preset when it is expected that a corresponding drive power will be called up or the reduction in the emitted torque by the driving dynamics control system will end. As a result, the maximum possible torque can be set at an early stage by the gas mixture pressure and, at the same time, the emitted torque can be reduced by the ignition angle setting, so that the possible torque can be called up quickly by means of the ignition angle. As a result, after a reduction in the torque of the internal combustion engine by the driving dynamics control system, the drive power can be made available quickly and a dead time of the drive power can be avoided. Consequently, the driving dynamics in the event of intervention by the driving dynamics control system can be generally improved.

In a preferred embodiment of the method, the torque reserve is further set on the basis of a driver's desired torque.

As a result, it is possible to check at an early stage whether dynamic and sporty driving is required or desired after intervention by the driving dynamics control system.

It is further preferred when the setpoint torque is reduced by an ignition angle retardation operation and/or by turning off the combustion in individual cylinders.

As a result, the emitted torque of the internal combustion engine can be reduced quickly with a low level of technical expenditure, so that slipping or yawing is avoided.

It is further preferred when a thermal power loss of the internal combustion engine is determined, and the power loss is limited on the basis of a loading limit of the internal combustion engine.

Owing to a torque reserve which is set according to the invention, high temperatures can generally be produced in the internal combustion engine and in the connected exhaust gas system, so that overloading of individual elements of the internal combustion engine or of the connected exhaust gas system can be avoided by limiting the power.

It is further preferred when the power loss is limited by deactivating individual cylinders or a plurality of cylinders of the internal combustion engine.

As a result, the power loss and the associated increased temperature in the internal combustion engine and the connected exhaust gas system can be quickly and effectively reduced, wherein it remains possible to quickly call up the maximum possible drive power.

It is further preferred when the power loss is limited by reducing or limiting the torque reserve.

As a result, the power loss can be limited in an effective and efficient manner.

It is further preferred when the provision of the torque reserve is limited with respect to time.

As a result, overheating of individual elements of the internal combustion engine and/or of the exhaust gas system can be avoided.

It is further preferred when the charge pressure is set to a maximum possible value, and the torque reserve is set by means of a throttle valve.

As a result, a maximum drive power which can be provided by the internal combustion engine can be provided at an early stage since the maximum possible pressure of the gas mixture which flows into the internal combustion engine can be set solely by opening the throttle valve.

It is further preferred when the driving situation is detected on the basis of a rate of rotation of the motor vehicle and/or a slip value of at least one driven wheel of the motor vehicle.

As a result, excessive slipping of the driven wheels and swinging out of the motor vehicle can generally be prevented with a low level of technical expenditure.

It is further preferred when the setpoint torque and the torque reserve are determined by a driving dynamics control unit and are requested by a control unit of the internal combustion engine in order to set the ignition angle and the gas mixture pressure.

As a result, the torque reserve can be ascertained and requested in a situation-specific manner and as required and the engine control unit can ensure that the loading limits of the internal combustion engine are not exceeded.

Overall, rapid and precise follow-up behavior of the internal combustion engine and quick provision of drive power can be ensured by virtue of the present invention, and at the same time the emitted drive power can be reduced and the loading limits of the internal combustion engine can be complied with for the purpose of stabilizing the motor vehicle. Therefore, the driving dynamics can also be ensured or increased overall in the event of intervention by stability control systems of the motor vehicle.

It goes without saying that the above features and those still to be explained below can be used both in the respectively indicated combination and also in other combinations or on their own, without departing from the scope of the present invention.

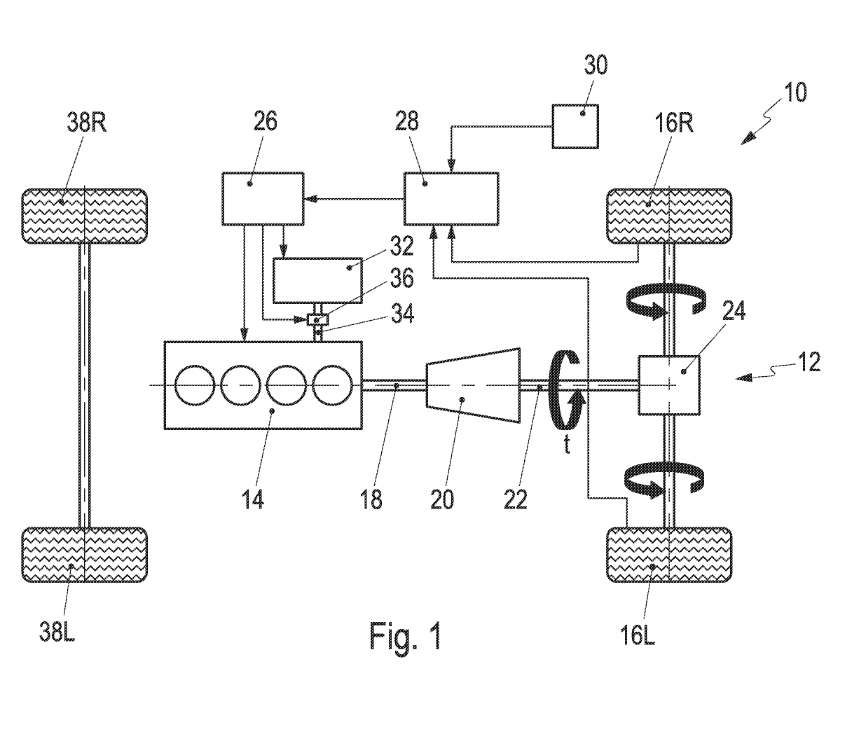

FIG. 1 schematically illustrates a motor vehicle and is denoted 10 in general. The motor vehicle 10 has a drive train 12 which, in the present case, contains an internal combustion engine 14 for providing drive power. The drive train 12 serves to drive driven wheels 16L, 16R of the motor vehicle 10.

The internal combustion engine 14 is connected to a gear mechanism 20 by means of a crankshaft 18. The gear mechanism 20 is connected to the driven wheels 16R, 16L by means of an output drive shaft 22 and a differential gear mechanism 24, in order to transmit a drive torque t to the driven wheels 16R, 16L.

The motor vehicle 10 has an engine control unit 26 which controls the internal combustion engine 14 in general. The motor vehicle 10 further has a driving dynamics control unit 28 which controls the driving dynamics of the motor vehicle 10 in general, and in particular controls a drive slip of the driven wheels 16R, 16L in order to prevent excessive wheelspin of the driven wheels 16R, 16L and swinging out or skidding of the motor vehicle 10 when traveling around a bend. In order to control the driving dynamics, the driving dynamics control unit 28 is connected to a sensor cluster 30 which detects a rate of rotation and also possibly a longitudinal acceleration of the motor vehicle 10. In order to control drive slip, the driving dynamics control unit 28 is further connected to the wheels 16R, 16L in order to detect a slip of the driven wheels 16R, 16L. It goes without saying that this relates to all of the wheels 16R, 16L, 38R, 38L in the case of all-wheel drive vehicles.

The motor vehicle 10 further has a compressor 32 which generates a charge pressure of the air which is supplied to the internal combustion engine 14, in order to achieve an increase in power of the internal combustion engine 14. The compressor 32 is preferably in the form of a turbocharger. A throttle valve 36, which sets a pressure of the air which is supplied to the internal combustion engine 14, is arranged in an intake manifold 34 of the internal combustion engine 14.

The engine control unit 26 controls, in particular, the throttle valve 36, in order to set an air pressure in the intake manifold 34 and in this way to set a torque which can be emitted by the internal combustion engine 14 by means of the crankshaft 18. Said torque, which is set by means of the intake manifold pressure, is called the base torque and forms the maximum possible torque under these conditions. The engine control unit 26 is further designed to set an ignition angle of the internal combustion engine 14 by means of the crankshaft 18, said ignition angle usually being matched to the pressure in the intake manifold 34 in order to emit the maximum torque of the internal combustion engine 14. Owing to a retardation operation of the ignition angle, the emitted torque can be reduced in addition to shutting off cylinders, wherein the difference between the base torque, which is determined by the intake manifold pressure, and the torque which is actually emitted by the ignition angle forms a torque reserve which can be called up quickly by adjusting or changing the ignition angle.

The driving dynamics control unit 28 detects a slip of the driven wheels 16R, 16L and/or a yaw rate on the basis of the sensor cluster 30 and from these/this determines a setpoint torque for the internal combustion engine 14 at which the slip of the driven wheels 16R, 16L is limited to a maximum value. In other words, the driving dynamics control unit 28 determines a torque for the internal combustion engine 14 which is lower than the currently emitted torque. Furthermore, the driving dynamics control unit 28 determines an expected driving situation of the motor vehicle 10 in which, for example, the slip limit of the driven wheels 16R, 16L is higher than in the current driving situation, specifically, for example, on the basis of a steering angle of steered wheels 38R, 38L of the motor vehicle 10. The driving dynamics control unit 28 uses the expected driving situation to ascertain a base setpoint torque of the internal combustion engine 14 at which no excessive slip of the driven wheels 16R, 16L occurs. The difference between the base setpoint torque and the setpoint torque forms the torque reserve, wherein the driving dynamics control unit 28 forwards the two torque values or the setpoint torque and the torque reserve to the engine control unit 26 and requests the corresponding values.

The motor control unit 26 then sets the base torque by means of the throttle valve 36 and the emitted torque by means of the ignition angle of the internal combustion engine 14. The difference between these two torques forms the torque reserve. When the driving situation of the motor vehicle 10 is changed and the slip limit of the driven wheels 16R, 16L is increased, the entire torque reserve can be requested by quickly changing the ignition angle, as a result of which it is possible for the motor vehicle to quickly respond after the drive torque has been reduced.

Since the setting of the maximum possible torque by opening the throttle valve 36 exhibits a certain amount of inertia and the corresponding torque can usually be provided to the crankshaft 18 only after a dead time of approximately 2 secs, it is necessary to ascertain an expected driving situation at an early stage and to correspondingly preset the base torque of the internal combustion engine 14 by means of the throttle valve 36 at an early stage. When the torque reserve is preset in this way, the requested torque can be provided quickly by adjusting the ignition angle, without any dead time.

When setting a high torque reserve, the elements of the internal combustion engine 14 and the exhaust gas system of the motor vehicle 10, such as the catalytic converter for example, become very hot, and therefore, when a large torque reserve is set over a relatively long period of time, corresponding elements of the internal combustion engine 14 and of the exhaust gas system of the motor vehicle 10 can be thermally overloaded and therefore damaged. In order to avoid thermally-related damage of this kind, the power loss is limited by the torque reserve, specifically by selectively switching off individual cylinders, by limiting an absolute value of the torque reserve and by limiting the provided torque reserve with respect to time.

In order to further increase the driving dynamics after the intervention by the driving dynamics control unit 28 and to provide a high drive power of the internal combustion engine 14 after a short time, the turbocharger 32 is preferably driven at a maximum drive power, that is to say that a bypass valve (waste gate) of the turbocharger 32 is completely closed, in order to drive the turbocharger 32 at maximum power. The pressure in the intake manifold 34 is correspondingly lowered by partially closing the throttle valve 36, and therefore the torque reserve can be set in accordance with the request made by the driving dynamics control unit 28. If the driving situation of the motor vehicle 10 allows a further increase in power, all of the drive power can be provided by the internal combustion engine 14 given a correspondingly short dead time, by opening the throttle valve 36, without a corresponding turbo lag being produced and the turbocharger 32 first having to warm up. The power of the turbocharger or the charge pressure upstream of the throttle valve 36 can be set by means of the driver's desire, in order to be able to quickly provide the desired torque after control by the driving dynamics control unit 28.

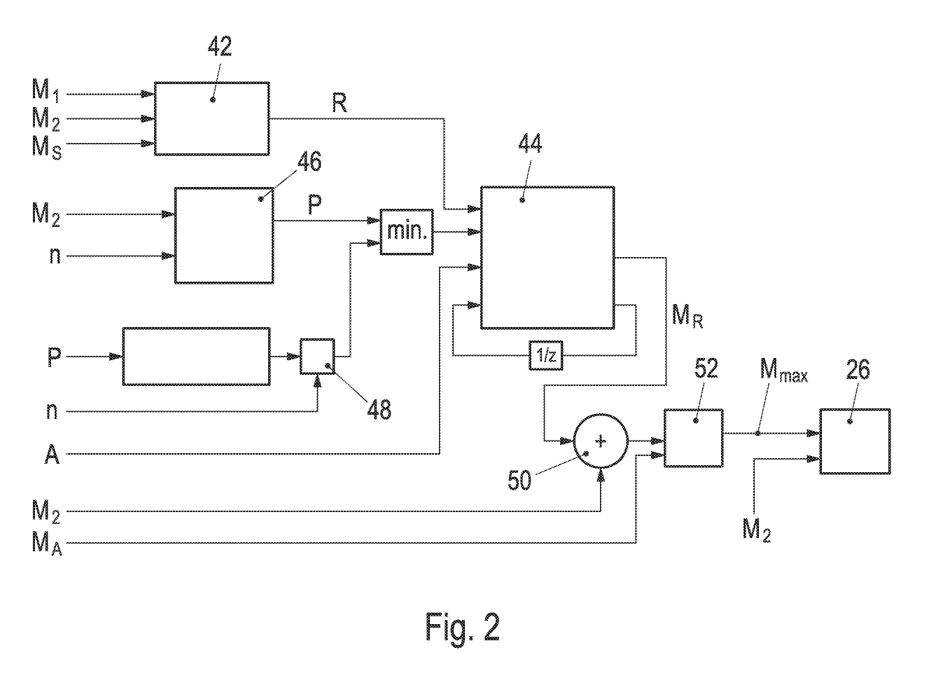

FIG. 2 schematically shows a schematic block diagram for determining the base torque or for determining the torque reserve.

In this case, a gradient for the torque increase or the torque reduction in the torque reserve is initially determined, specifically with a constant 42. In this case, the base torque is M1, the setpoint torque is M2 and the setpoint torque reserve is MS. The gradient R is forwarded to a gradient limiter 44. A torque reserve is ascertained by means of a characteristic map 46 on the basis of the requested setpoint torque M2 and a rotation speed n of the internal combustion engine 14. A characteristic curve of the maximum power loss P with respect to the time for which the setpoint torque reserve MS is active is ascertained in a characteristic curve operator 48 and a divisor 49, in order to allow the power loss to be correspondingly limited. A minimum value is ascertained from the characteristic curve and the power loss P and is forwarded to the gradient limiter 44. As a further input variable, the gradient limiter 44 receives a signal A from a control-related observer stating whether a torque reserve is requested. The gradient limiter 44 ascertains a value for the torque reserve MR from the input variables R, P, A, said torque reserve being added to the setpoint torque M2 of the internal combustion engine at a summation point 50 and then being combined in a second gradient limiter 52 together with a requested torque MA of the driver to form a base setpoint torque MB which is requested as the torque reserve by the engine control unit 26 and, as described above, is formed by setting the throttle valve 36. In parallel to this, the engine control unit 26 is provided with the setpoint torque M2 by means of a separate channel or said setpoint torque is requested by the engine control unit 26.

As a result, the emitted torque M2 and the torque reserve can be set and requested by the engine control unit 26 by virtue of the method which is illustrated in the block diagram in FIG. 2, wherein a power limit is taken into account at the same time.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for controlling an internal combustion engine of a motor vehicle, comprising the steps of:
detecting a driving situation of the motor vehicle;
determining a setpoint torque (M2) based on the detected driving situation;
ascertaining an expected driving situation of the motor vehicle;
determining a torque reserve based on the ascertained expected driving situation of the motor vehicle;
setting the setpoint torque (M2) by setting an ignition angle of the internal combustion engine; and
setting the torque reserve (MR) by setting a pressure of a gas mixture that flows into the internal combustion engine.

2. The method as claimed in claim 1, wherein the torque reserve (MR) is further set based on a driver's desired torque (MA).

3. The method as recited in claim 1, wherein the setpoint torque (M2) is reduced by an ignition angle retardation operation.

4. The method as recited in claim 1, wherein a charge pressure of the internal combustion engine is set based on the driver's desired torque (MA).

5. The method as recited in claim 1, wherein a thermal power loss (P) of the internal combustion engine is determined, and the power loss is limited based on a loading limit of the internal combustion engine.

6. The method as recited in claim 1, wherein the power loss (P) is limited by deactivating at least one cylinder.

7. The method as recited in claim 1, wherein the power loss (P) is limited by reducing or limiting the torque reserve (MR).

8. The method as recited in claim 1, wherein the charge pressure is set to a maximum possible value, and the torque reserve (MR) is set by means of a throttle valve.

9. The method as recited in claim 1, wherein the driving situation is detected on based on at least one of a rate of rotation of the motor vehicle or a slip value of at least one driven wheel of the motor vehicle.

10. The method as recited in claim 1, wherein the setpoint torque (M2) and the torque reserve (MR) are determined by a driving dynamics control unit and are requested by a control unit of the internal combustion engine in order to set the ignition angle and the gas mixture pressure.

11. An apparatus for controlling an internal combustion engine of a motor vehicle, the apparatus comprising:
a driving dynamics control unit configured to detect a driving situation of the motor vehicle and to determine a setpoint torque (M2) for the internal combustion engine based on the detected driving situation, the driving dynamics control unit being configured to ascertain an expected driving situation and to determine a torque reserve (MR) for the internal combustion engine on the basis of the expected driving situation, and
a control unit configured to set an ignition angle of the internal combustion engine based on the determined setpoint torque (M2), and to set based on the determined torque reserve (MR) a pressure of a gas mixture which flows into the internal combustion engine.
